(19) United States
(12) Patent Application Publication
(10) Pub. No.: US 2012/0303319 A1
(43) Pub. Date: Nov. 29, 2012

(54) PEDOMETER DEVICE AND STEP DETECTION METHOD

(75) Inventor: Ole Kirkeby, Espoo (FI)

(73) Assignee: NOKIA CORPORATION, Espoo (FI)

(21) Appl. No.: 13/575,487

(22) PCT Filed: Feb. 2, 2010
(86) PCT No.: PCT/IB10/50455

§ 371 Date: Jul. 26, 2012

(51) Int. Cl. G01C 22/00

(52) U.S. Cl. 702/160

(57) ABSTRACT

An apparatus comprising at least one processor and at least one memory including computer program code the at least one memory and the computer program code configured to, with the at least one processor, cause the apparatus at least to perform: generating a first processed accelerometer sample signal from a first accelerometer sample signal; determining a step event from the first processed accelerometer sample signal; and controlling processing of a second accelerometer sample signal for a first time period.

The present invention relates to apparatus for step counting. The invention further relates to, but is not limited to, apparatus for step counting or pedometers and in mobile communication devices.

Commercial step counters are widely known and are often used in order to allow a person to monitor their physical activity during the day. In a simple step counter a mechanical spring is used to detect steps as the mechanical spring acts as (or against) a mechanical switch to detect steps and is connected to a simple counter. However the switch can be easily fooled, for example by rapidly shaking the device and generating artificially high number of counted steps. Furthermore such devices are typically required to be attached to the belt in order to accurately measure the number of steps and thus placing the device in a pocket or holding it in the hand may produce inaccurate results.

In order to overcome the problem with mechanical step counters, some step counters now rely on microelectromechanical system (MEMS) inertial sensors to detect steps. The use of these MEMS inertial sensors allow a more accurate detection of steps and have fewer false positive results. However these are typically expensive and also have a fairly high power consumption.

For example some personal electronic devices such as some mobile phones, have implemented MEMS inertial sensors and thus enable a single device to share expensive display and processing capability for more than one function. For example the Nokia 5500 sports phone uses an embedded 3-axis MEMS inertial sensor to detect the steps a user takes. The step counter or pedometer application within the Nokia 5500 then tracks the steps taken, time lapsed and distanced traveled (once a standardised step distance has been entered). However, the application cannot be run continuously on the apparatus as the drain on the mobile device's battery is increased significantly over the “normal” power drain in the same way that the dedicated MEMS step counters also have high power consumption issues.

This invention thus proceeds from the consideration that by efficient processing of the output of the step or motion sensors, it may be possible to decrease the power requirements for a pedometer or step counter application or apparatus.

Embodiments of the present invention aim to address the above problem.

There is provided according to a first aspect of the invention a method comprising: generating a first processed accelerometer sample signal from a first accelerometer sample signal; determining a step event from the first processed accelerometer sample signal; and controlling processing of a second accelerometer sample signal for a first time period.

Generating a first processed accelerometer sample signal may comprise generating an approximation to the magnitude of the accelerometer sample signal.

The approximation to the magnitude of the accelerometer sample signal may be the root means square value of the accelerometer sample signal.

The accelerometer sample signal may comprise a downsampled accelerometer signal.

Determining a step event preferably comprises: comparing the first processed accelerometer sample signal against a predetermined threshold value; and detecting the first processed accelerometer sample signal value is greater than the predetermined threshold value.

Controlling processing of the second accelerometer sample signal for a first time period preferably comprises: switching the second accelerometer sample signal for a first time period to stop processing the second accelerometer sample signals for the first time period.

Switching the second accelerometer sample signal for a first time period to stop processing the second accelerometer sample signals for the first time period preferably comprises latching the second accelerometer sample signal for a number of samples defining the first time period.

The number of samples defining the first time period is preferably dependent on a frequency of detected step events.

The method may further comprise generating the first accelerometer sample signal and the second accelerometer sample signal, wherein the second accelerometer sample signal follows the first accelerometer signal.

Generating the first accelerometer sample signal and the second accelerometer sample signal preferably comprises: generating at least one analogue signal, wherein each analogue signal represents the acceleration in a direction; and digitizing the at least one analogue signal to generate an accelerometer sample signal.

The first accelerometer sample signal and the second accelerometer sample signal each may comprise at least one accelerometer axis value.

According to a second aspect of the invention there is provided an apparatus comprising at least one processor and at least one memory including computer program code the at least one memory and the computer program code configured to, with the at least one processor, cause the apparatus at least to perform: generating a first processed accelerometer sample signal from a first accelerometer sample signal; determining a step event from the first processed accelerometer sample signal; and controlling processing of a second accelerometer sample signal for a first time period.

The apparatus caused to at least perform generating a first processed accelerometer sample signal is preferably further caused to perform generating an approximation to the magnitude of the accelerometer sample signal.

The approximation to the magnitude of the accelerometer sample signal may be the root means square value of the accelerometer sample signal.

The accelerometer sample signal preferably comprises a downsampled accelerometer signal.

The apparatus caused to at least perform determining a step event is preferably further caused to perform: comparing the first processed accelerometer sample signal against a predetermined threshold value; and detecting the first processed accelerometer sample signal value is greater than the predetermined threshold value.

The apparatus caused to at least perform controlling processing of the second accelerometer sample signal for a first time period is preferably further caused to perform switching the second accelerometer sample signal for a first time period to stop processing the second accelerometer sample signals for the first time period.

The apparatus caused to at least perform switching the second accelerometer sample signal for a first time period to stop processing the second accelerometer sample signals for the first time period is preferably further caused to perform latching the second accelerometer sample signal for a number of samples defining the first time period.

The number of samples defining the first time period may be dependent on a frequency of detected step events.

The apparatus may be further caused to perform generating the first accelerometer sample signal and the second accelerometer sample signal, wherein the second accelerometer sample signal follows the first accelerometer signal.

The apparatus caused to at least perform generating the first accelerometer sample signal and the second accelerometer sample signal is preferably further caused to perform: generating at least one analogue signal, wherein each analogue signal represents the acceleration in a direction; and digitizing the at least one analogue signal to generate a accelerometer sample signal.

The first accelerometer sample signal and the second accelerometer sample signal may each comprise at least one accelerometer axis value.

According to a third aspect of the invention there is provided an apparatus comprising: a signal processor configured to generate a first processed accelerometer sample signal from a first accelerometer sample signal; a step event determiner configured to determine a step event from the first processed accelerometer sample signal; and a controller for controlling processing of a second accelerometer sample signal for a first time period.

The signal processor may be configured to generate an approximation to the magnitude of the accelerometer sample signal.

The signal processor may comprise a root mean squarer configured to generate a root mean square value of the accelerometer sample signal.

The signal processor may comprise a downsampler configured to generate downsampled accelerometer signal samples.

The step event determiner may comprises: a comparator configured to compare the first processed accelerometer sample signal against a predetermined threshold value; and a threshold detector configured to detect the first processed accelerometer sample signal value is greater than the predetermined threshold value.

The controller may comprise: a switch configured to switch the second accelerometer sample signal for a first time period to stop processing the second accelerometer sample signals for the first time period.

The switch may comprise a latch configured to latch the second accelerometer sample signal for a number of samples defining the first time period.

The number of samples defining the first time period is preferably dependent on a frequency of detected step events.

The apparatus may further comprise: an accelerometer configured to generate the first accelerometer sample signal and the second accelerometer sample signal, wherein the second accelerometer sample signal follows the first accelerometer signal.

The accelerometer may comprise: an analogue accelerometer configured to generate at least one analogue signal representing the acceleration in a direction; and an analogue to digital converter configured to digitize the at least one analogue signal.

The accelerometer may comprise at least one accelerometer axis component.

According to a fourth aspect of the invention there is provided an apparatus comprising: signal processing means configured to generate a first processed accelerometer sample signal from a first accelerometer sample signal; step event determining means configured to determine a step event from the first processed accelerometer sample signal; and a processing controller means for controlling processing of a second accelerometer sample signal for a first time period.

According to a fifth aspect of the invention there is provided a computer-readable medium encoded with instructions that, when executed by a computer perform: generating a first processed accelerometer sample signal from a first accelerometer sample signal; determining a step event from the first processed accelerometer sample signal; and controlling processing of a second accelerometer sample signal for a first time period.

An electronic device may comprise apparatus as described above.

A chipset may comprise apparatus as described above.

### BRIEF DESCRIPTION OF DRAWINGS

For better understanding of the present invention, reference will now be made by way of example to the accompanying drawings in which:

FIG. 1 shows schematically an electronic device employing embodiments of the application;

FIG. 2 shows schematically the electronic device shown in FIG. 1 in further detail;

FIG. 3 shows schematically a flow chart illustrating the operation of some embodiments of the application;

FIG. 4 shows schematically an example output from a 3-channel accelerometer;

FIG. 5 shows schematically an example output from a RMS processor shown in FIG. 2; and

FIG. 6 shows schematically a further example output from the RMS processor as shown in FIG. 2 according to some embodiments of the application.

### DETAILED DESCRIPTION OF SOME EMBODIMENTS

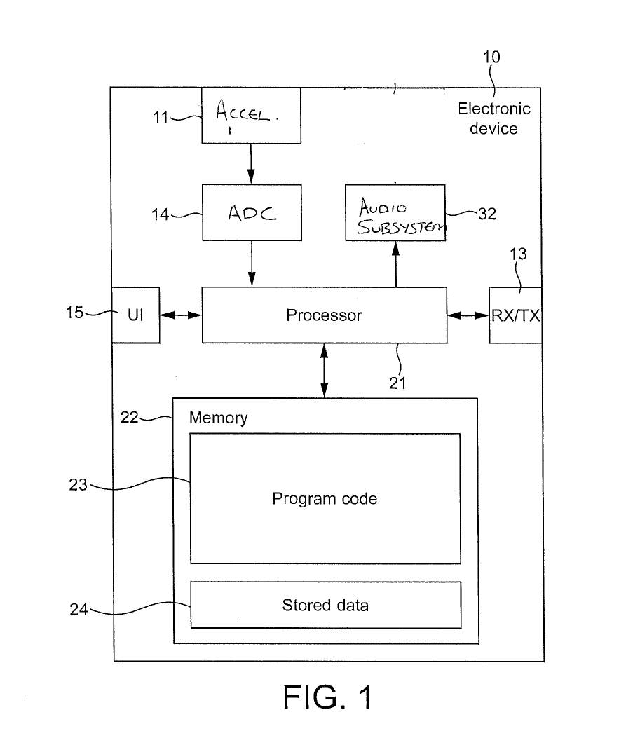

The following describes apparatus and methods for the provision of enhancing step counting apparatus and applications in electronic devices or apparatus. In this regard reference is made to FIG. 1 which shows a schematic block diagram of an exemplary electronic device or apparatus, which may incorporate step counter or pedometer capacity.

The apparatus may for example be a mobile terminal, user equipment, or a wireless communication apparatus. In some other embodiments the electronic device or apparatus may be any audio player (also known as MP3 players), a media player (also known as MP4 players), or portable apparatus equipped with suitable sensors. In some other embodiments the apparatus may be any suitable electronic device such as personal data assistant (PDA), tablet computer, notebook, net book or other mobile personal computer.

The apparatus comprises a processor which may be connected via an analogue-to-digital converter 14 to an accelerometer 11.

The accelerometer 11 may be a three channel (also known as three axis) accelerometer, wherein each channel accelerometer is configured to determine an in-plane acceleration perpendicular to the other two accelerometer channels. In some embodiments the accelerometer is a microelectromechanical system (MEMS) cantilever beam with a proof mass (or seismic mass) mounted at the open beam end. In such embodiments when the accelerometer channel experiences an in-plane acceleration, the mass is displaced to the point that the beam is able to accelerate the mass at the same rate as the casing. The displacement may then be measured to provide the acceleration within that plane. The deflection of the proof mass from the neutral position is detected in some embodiments whereby the capacitive effect between a set of fixed beams and the set of beams attached to the proof mass may be measured. In some other embodiments of the application a piezoresistor can be integrated within the beam to detect deformation of the beam and be used to produce a measured result.

In other embodiments other known MEMS or spring mass accelerometer configurations may be implemented in order to supply values dependent on the detected acceleration.

The output of the accelerometer 11 may in some embodiments be passed to the processor via an analogue-to-digital converter 14 configured to convert an analogue output from the accelerometer (when the accelerometer is an analogue signal producing accelerometer) to a digital signal suitable for the processor 21.

The apparatus 10 in some embodiments comprises a processor 21 in some embodiments the apparatus 10 comprises and the processor 21 is connected to an audio sub-system 32 configured to input audio to and/or output audio from the apparatus. The audio sub-system thus in some embodiments comprises a headphone, ear worn speaker headset, or any suitable audio transducer equipment suitable to output acoustic waves to a user's ears from the electronic audio signal. In some embodiments the transducer equipment may comprise a DAC for converting digital audio signals to an analogue format suitable to apply to the transducer. Furthermore in some embodiments the transducer may connect to the apparatus 10 wirelessly via a transmitter or transceiver, for example by using a low power radio frequency connection such as Bluetooth A2DP profile or a Bluetooth LE (Low Energy) Profile.

The processor 21 is in some embodiments further linked to a transceiver (TX/RX) 13, to a user interface (UI) 15 and to a memory 22.

The processor 21 may be configured to execute various program codes. The implemented program codes may in some embodiments comprise a step counter or pedometer application. The implemented program codes 23 may be stored for example in the memory 22 for retrieval by the processor 21 whenever needed. The memory 22 could further provide a section 24 for storing data, for example data that has been processed in accordance with the embodiments.

The step counter or pedometer application code may in embodiments be implemented in hardware or firmware.

The user interface 15 enables a user to input commands to the apparatus 10, for example via a keypad and/or a touch interface. Furthermore the apparatus 10 may comprise a display. The processor in some embodiments may generate image data to inform the user of the mode of operation and/or display a series of options from which the user may select using the user interface 15. For example the user may select to display the total number of steps detected or select the estimated distance traveled calculated dependent on the number of steps taken. In some embodiments the user interface 15 in the form of a touch interface may be implemented as part of the display in the form of a touch screen user interface.

The transceiver 13 in some embodiments enables communication with other electronic devices, for example via cellular or mobile phone gateway servers such as Node B or base transceiver stations (BTS) and a wireless communication network, or short range wireless communications to the microphone array or EWS where they are located remotely from the apparatus.

It is to be understood again that the structure of the electronic device 10 could be supplemented and varied in many ways.

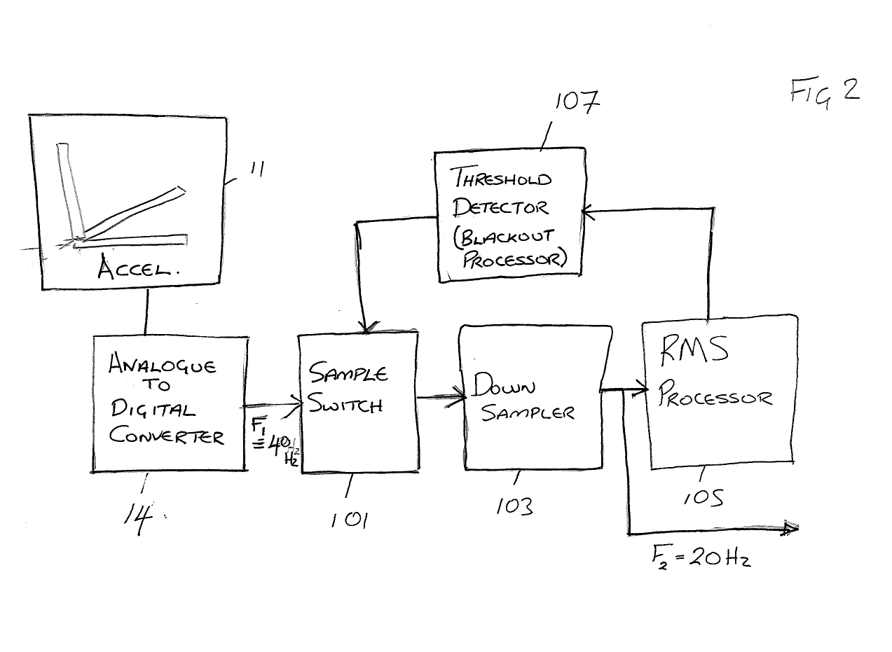

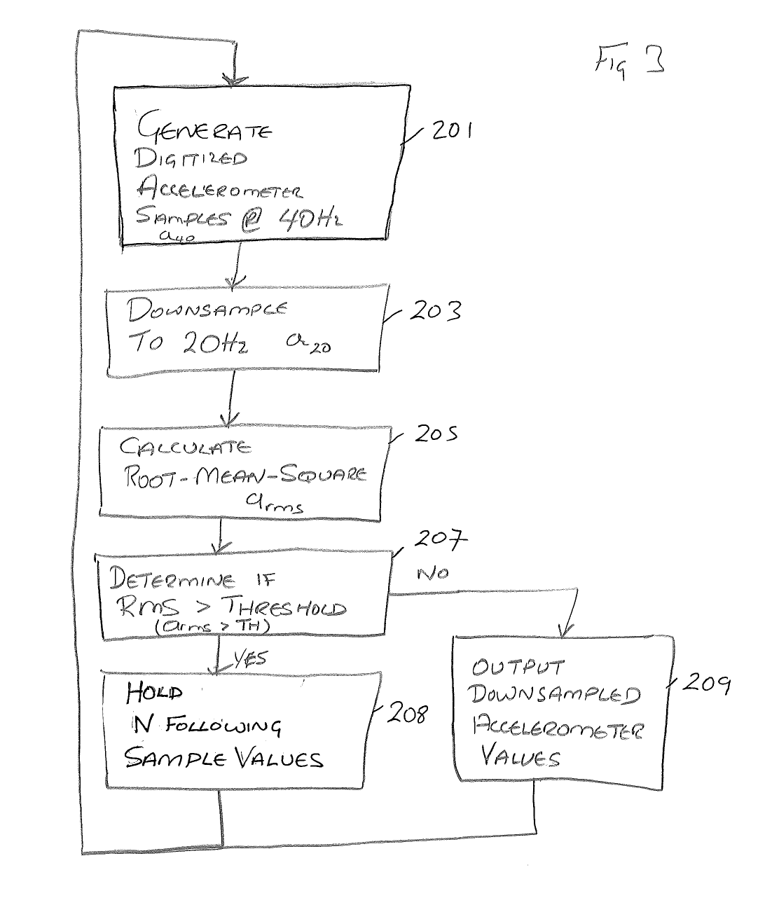

It would be appreciated that the schematic structures described in FIG. 2 and the method steps in FIG. 3 represent only a part of the operation of an apparatus comprising some embodiments as exemplarily shown implemented in the apparatus shown in FIG. 1.

With respect to FIG. 2 and FIG. 3 some examples of embodiments of the application as implemented and operated are shown in further detail.

The accelerometer 11, which as described above in some embodiments is a three channel accelerometer, it is configured to output in each of the three mutually perpendicular dimensions an analogue signal reflecting the current acceleration in each of the three mutually perpendicular directions. The analogue signal thus may be represented mathematically by the time varying analogue signals X(t), Y(t) and Z(t), or as a whole by the vector a={X(t), Y(t), Z(t)}.

With respect to FIG. 4, an example of the raw acceleration output is shown. The X(t) channel signal 401, the Y(t) channel signal 403 and the Z(t) channel signal 405 is shown over a time period.

The accelerometer signal a can then be passed to the analogue-to-digital converter (ADC) 14 for conversion into the digital domain.

The analogue-to-digital converter (ADC) 14 as described receives the analogue accelerometer X(t), Y(t) and Z(t) signals and digitizes these signals to produce digital samples X[n], Y[n], Z[n] (or X, Y, Z when ignoring the sample index n) at a specific sample rate. In a first example, the analogue-to-digital converter 14 may sample the output signals from the accelerometer at 40 Hz. Furthermore the analogue-to-digital converter may sample the three signals X(t), Y(t), Z(t) using an 8 bit representation. In some other embodiments (the analogue-to-digital converter 14 may output any number of bits per channel signal sample and may sample the signals at any suitable sample rate. For example the ADC could further sample the signal using a 12 bit or 16 bit per sample representation).

Furthermore in some embodiments the analogue-to-digital converter outputs a digitised signal scaled to a maximum output. For example in some embodiments the analogue-to-digital converter 14 outputs a maximum output at 2 g (in other words for each channel a maximum value would be generated when experiencing an acceleration of 2×9.81 ms⁻²). The digitized output from the ADC 14 may be mathematically represented as A={X, Y, Z}). It would be understood that the maximum value may be set at a level in some embodiments other than that of 2 g.

In some embodiments the accelerometer 11 outputs digitized samples, for example by comprising both accelerometer and digitizer.

The output of the analogue-to-digital converter 14 may be passed to a sample switch (or hold circuit) 101. The sample switch (or hold circuit) 101 is configured to either pass or block the sample output signals from the analogue-to-digital converter dependent on a control signal received from the blackout processor or threshold detector 107. The sample switch may for example be implemented by a latched logic gate.

The operation of generating and passing a digitized accelerometer sample at a first frequency operation is shown in FIG. 3 by step 201.

In embodiments the sample switch is initially switched open enabling the output from the analogue-to-digital converter 14 signals are passed to a down sampler 103 from the output of the sample switch 101.

The down sampler 103 is configured to reduce the sampling frequency by a predetermined factor. In some embodiments this predetermined factor is a factor of 2 and may be processed by summing corresponding pairs in the most recent two samples of the accelerometer data. In other words where the output of the accelerometer when digitized is represented as A=(X, Y, Z) then the output of the down sampler A_{D} may, for example be generated

A_{D}=A[n]+A[n−1],

where n is a sample index.

Thus in the above example where the original digitized frequency is 40 Hz and the predetermined down sampling factor is 2 then the output of the down sampler 103 is the sample triple of accelerometer data at 20 Hz.

The operation of down sampling to a lower frequency, is shown in FIG. 3 by step 203.

The output of the down sampler 103 is passed to the root mean square processor 105.

The root mean square processor is configured to calculate the root mean square value from the down sampled accelerometer data A_{D}. The root mean square processor 105 may output a root mean square value of the down sampled X, Y and Z channel data using any suitable algorithm. For example in some embodiments the root mean square processor 105 may determine an approximate root mean square value using fixed point precision using a following formula

$$\begin{matrix}{A}_{RMS} = sqrt ( {X}^{*} X + {Y}^{*} Y + {Z}^{*} Z ) \\ \approx {( 45 / 128 )}^{*} SUM ( abs ( X ) , abs ( Y ) , abs ( Z ) ) + \\ {( 77 / 128 )}^{*} MAX ( abs ( X ) , abs ( Y ) , abs ( Z ) ) \\ \approx 45 * SUM ( abs ( X ) , abs ( Y ) , abs ( Z ) ) + \\ {77}^{*} MAX ( abs ( X ) , abs ( Y ) , abs ( Z ) ) >> 7\end{matrix}$$

Where the samples are represented by an 8-bit number. Furthermore sum( ) is the scalar sum of all the vector's values {abs(X),abs(Y),abs(Z)}, MAX( ) is the maximum of the vector values {abs(X),abs(Y),abs(Z)} is the absolute value of A and >>7 indicates a shift of the value 45*SUM(A_{D})+77*MAX(A_{D}) right by 7 bits (in other words a division of 2⁷ or 128).

The output of the RMS processor 105 is passed to the threshold detector, also known as the blackout processor 107.

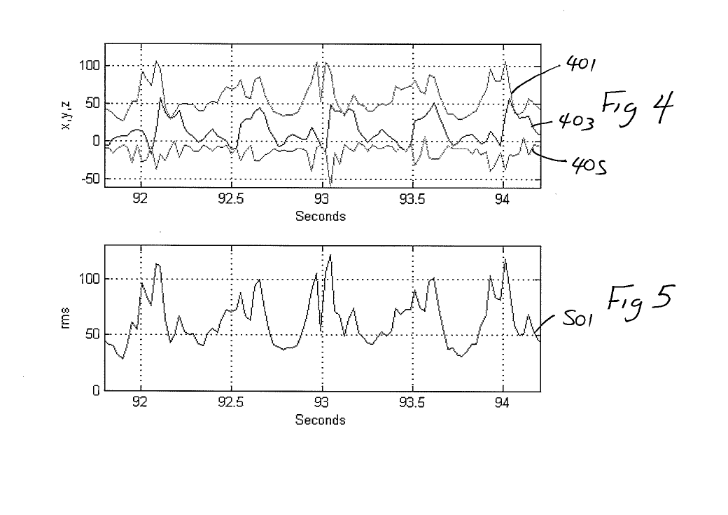

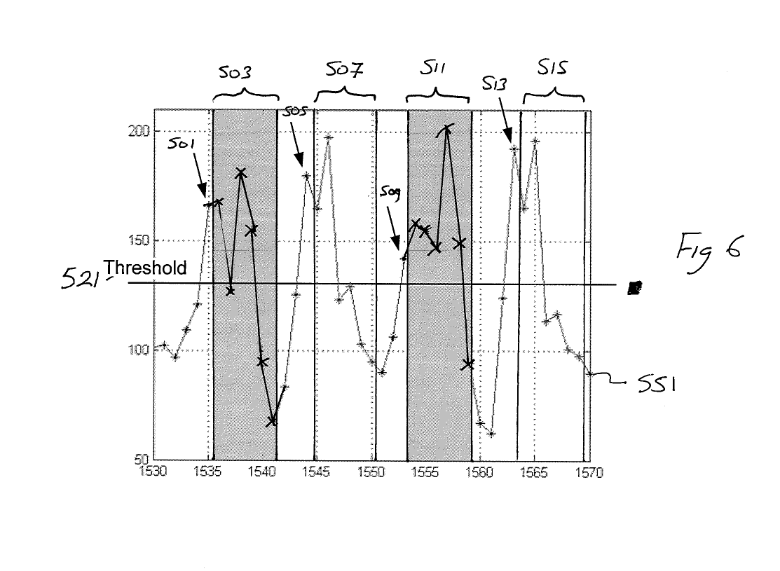

With respect to FIG. 5, the RMS value associated with the A_{D} down sampled channel accelerometer outputs shown in FIG. 4 is shown. The RMS trace 501 would ideally be expected to be a sinusoidal waveform, however step events are typically not particularly well divided in practice and as shown in FIG. 5 there is a difference between the signal recorded when the user stops with the left foot and the right foot. This asymmetry is caused typically by the accelerometer being located to one side of the body rather at the body than the centre. Furthermore although the RMS signal shown in FIG. 5 appears to be noisy, it is a typically good example of a step profile such as produced when as the operator of the device carries the apparatus in a jacket pocket or bag worn over the shoulder. It would be appreciated that the signal could be much noisier when the device is for example located within a trouser pocket or carried in the hand.

As shown in the example in FIG. 5 a step event occurs approximately every 0.5 seconds starting for example at the 92 second point.

The calculation of the root mean square value of each triple is shown in FIG. 3 by step 205.

Although the above describes a root mean square processor it would be understood that in some other embodiments a similar result may be achieved by the apparatus comprising a signal processor configured to generate an approximation to the magnitude of the accelerometer sample signal.

The threshold detector 107 also known as the blackout processor receives the RMS sample values and determines whether or not the RMS value is greater than a predetermined threshold value. Where the threshold detector 107 determines that the RMS value is equal to or below the threshold value, the threshold detector maintains the sample switch open. In some embodiments this may be achieved by asserting an input to the sample switch 101 at a first logic level. This in some embodiments enables the down sampled values to be output and allows further samples to be passed to the down sampler to be further output and calculated.

The operation of determining if the RMS is greater than the threshold is shown in FIG. 3 by step 207.

Furthermore the operation of outputting down sampled accelerometer values is shown in FIG. 3 by step 209.

Where the threshold detector 107 determines that the RMS value is greater than the predetermined threshold value then the threshold detector 107 controls the sample switch to hold or block any further sample values for a predetermined number of samples. In some embodiments this may be achieved by asserting an input to the sample switch 101 at a second logic level for the predetermined number of sample clock cycles, before asserting the input to the first logic level again.

The operation of holding the predetermined number (N) of following sample values is shown in FIG. 3 by step 208.

A typical person's step rate (in steps per minute [SPM]) is within the range of between 60 and 140 steps per minute as the person is walking and usually falls within a range of between 100 to 120 SPM as the person is walking naturally. This may rise to a range between 150 and 180 SPM when the person is jogging or running and above 200 when performing extremely fast sprinting. Thus typically a step counter or pedometer application should be required to detect events within the frequency band between 1 Hz and 3 Hz. A sampling frequency of 40 Hz as used in the example for sampling the raw accelerometer data thus is clearly very high and significantly over samples the signal requiring in a typical step counter processing at a rate of 40 times a second. The embodiments described above allow a significant reduction is processing power requirement by enforcing a “blackout” period immediately after a step event is detected, i.e. when the RMS value reaches a significant predetermined threshold.

With respect to FIG. 6, this is shown by the RMS signal trace 551 which when passing above the predetermined threshold 521 (which in this example has a value of 128) then enforces a blackout or hold period of 6 samples at a down converted sample rate of 20 Hz. Thus for example as shown in FIG. 6, a first step event is detected at a sample 501 above the threshold 521 and the following 6 samples at the down converted rate are held, the samples falling within the first blackout region or period 503. Similarly a further sample 505 above the threshold 521 triggers a second blackout period 507, a third sample 509 above the threshold 521 triggers a third blackout period 511 and a fourth sample 513 above the threshold 521 triggers a fourth blackout period 515.

The length of blackout period thus effectively sets an upper limit for the step rate. At 20 Hz six samples correspond to approximately a third of a second or in other words a maximum step detection rate of approximately 3 Hz, which is the maximum expected step frequency. In the embodiments shown above the blackout period is implemented by the sample switch 101 being located before the down sampler and thus at the higher sample rate in such embodiments the blackout period is equivalent to 12 samples at 40 Hz. In other embodiments the blackout period may be set to more than or less than 12 samples at 40 Hz.

In some embodiments the sample switch 101 may be implemented after the down sampler 103 and thus the blackout period be defined using the lower frequency sample number (for example a 6 sample blackout period).

In embodiments implementing the blackout period when the blackout period is implemented it creates a period when processing may be paused. In such embodiments the processing requirements and thus application or apparatus elements may reduce power consumption.

Although the above examples have been described with respect to a 40 Hz original sampling frequency and a downsampling which reduced the original sampling frequency to 20 Hz it would be understood that embodiments of the application may be implemented for any suitable original sampling frequency and downsampled frequency providing a suitable blackout period number of samples are chosen. For example as described above the maximum expected frequency for reasonable step counting is 3 Hz, and as such a period length should not typically be chosen to be greater than 0.3 s so that the next step is missed.

In some embodiments the blackout period may be adjustable. For example in some embodiments the blackout period may track the current step frequency and adjust the blackout period to be as long as possible but without missing any steps. Thus as the user moves from a run to a walk the blackout period is increased so as to attempt to optimize power consumption. For example where a 3 Hz pace is detected the threshold detector 107 may select a number of samples for the blackout period such that the blackout period is less than but near to 0.3 seconds, whereas as the pace slows to 1 Hz the a bigger sample number representing the blackout period may be chosen so that the blackout period is less than but near to 1 second.

Furthermore although the embodiments described above describe a three channel accelerometer it would be understood that in some embodiments of the application a two channel accelerometer (such that the accelerometer in these embodiments is configured to output an analogue or digital signal reflecting the current acceleration in two mutually perpendicular directions a={X(t),Y(t)}, or a single channel accelerometer (such that the accelerometer in these embodiments is configured to output an analogue signal reflecting the current acceleration in one dimension a={X(t)}). In such embodiments the same operations may thus be carried out on the two or one dimension signals.

These embodiments have the further advantage that steps are not detected for a period immediately following a previous step event. As such a step count, in these embodiments, can be significantly more reliable as rogue step events caused by noise during walking are masked by the blackout period. Thus this in some embodiments further reduces the requirement for further processing of the detected step events. In some devices an accept/reject decision function or processing is required to filter rogue or error step detections (a false positive detection) which further requires processing capacity and power requirements.

However in some embodiments as described above the blackout period function processing may assist in preventing some error step detections and thus reduce the processing requirement of having a accept/reject decision function. Furthermore even where in some embodiments which feature an accept/reject decision function, the operation of such a function may be only necessary when a step is detected and as such by implementing a blackout period the maximum frequency at which the function is required may be reduced. It is thus in some embodiments computationally cheap to implement and thus can be run separately even at the application level.

Thus in some embodiments the advantages are that the detection may be simply implemented, can be written in assembly language when implemented in a processor and included with the accelerometer hardware, can be very power efficient and thus reduce battery drain, and also is accurate when calculating steps, particularly when using it with a reject/accept decision function.

Thus in summary there is a method comprising generating a first processed accelerometer sample signal from a first accelerometer sample signal, determining a step event from the first processed accelerometer sample signal and controlling processing of a second accelerometer sample signal for a first time period.

It shall be appreciated that the term electronic device and user equipment is intended to cover any suitable type of wireless user equipment, such as mobile telephones, portable data processing devices or portable web browsers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus at least one embodiment comprises an apparatus comprising: a signal processor configured to generate a first processed accelerometer sample signal from a first accelerometer sample signal; a step event determiner configured to determine a step event from the first processed accelerometer sample signal; and a controller for controlling processing of a second accelerometer sample signal for a first time period.

The signal processor may in some embodiments be a root mean squarer configured to generate a root mean square value of the accelerometer sample signal. The signal processor may furthermore comprise a downsampler configured to generate downsampled accelerometer signal samples.

The step event determiner in such embodiments may comprise a comparator configured to compare the first processed accelerometer sample signal against a predetermined threshold value and a threshold detector configured to detect the first processed accelerometer sample signal value is greater than the predetermined threshold value.

The controller in these embodiments may comprise a switch configured to switch the second accelerometer sample signal for a first time period to stop processing the second accelerometer sample signals for the first time period. The switch may comprise a latch as described above configured to latch the second accelerometer sample signal for a number of samples defining the first time period. The number of samples defining the first time period is preferably dependent on a frequency of detected step events.

The apparatus may also further comprise an accelerometer configured to generate the first accelerometer sample signal and the second accelerometer sample signal, wherein the second accelerometer sample signal follows the first accelerometer signal. The accelerometer may comprise an analogue accelerometer configured to generate at least one analogue signal representing the acceleration in a direction, and an analogue to digital converter configured to digitize the at least one analogue signal. The accelerometer as also discussed above may comprise at least one accelerometer axis component.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

For example there may be provided a computer-readable medium encoded with instructions that, when executed by a computer perform: generating a first processed accelerometer sample signal from a first accelerometer sample signal; determining a step event from the first processed accelerometer sample signal; and controlling processing of a second accelerometer sample signal for a first time period.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
generating a first processed accelerometer sample signal from a first accelerometer sample signal;
determining a step event from the first processed accelerometer sample signal; and
controlling processing of a second accelerometer sample signal for a first time period.

2. The method as claimed in claim 1, wherein generating a first processed accelerometer sample signal comprises generating an approximation to the magnitude of the accelerometer sample signal.

3. The method of claim 1, wherein the accelerometer sample signal comprises a downsampled accelerometer signal.

4. The method of claim 1, wherein determining a step event comprises:
comparing the first processed accelerometer sample signal against a predetermined threshold value; and
detecting the first processed accelerometer sample signal value is greater than the predetermined threshold value.

5. The method of claim 1, wherein controlling processing of the second accelerometer sample signal for a first time period comprises:
switching the second accelerometer sample signal for a first time period to stop processing the second accelerometer sample signals for the first time period.

6. The method of claim 5, wherein switching the second accelerometer sample signal for a first time period to stop processing the second accelerometer sample signals for the first time period comprises:
latching the second accelerometer sample signal for a number of samples defining the first time period.

7. The method of claim 6, wherein the number of samples defining the first time period is dependent on a frequency of detected step events.

8. The method of claim 1, further comprising generating the first accelerometer sample signal and the second accelerometer sample signal, wherein the second accelerometer sample signal follows the first accelerometer signal.

9. The method of claim 8, wherein generating the first accelerometer sample signal and the second accelerometer sample signal comprises:
generating at least one analogue signal, wherein each analogue signal represents the acceleration in a direction; and
digitizing the at least one analogue signal to generate a accelerometer sample signal.

10. The method of claim 1, wherein the first accelerometer sample signal and the second accelerometer sample signal each comprise at least one accelerometer axis value.

11. An apparatus comprising at least one processor and at least one memory including computer program code the at least one memory and the computer program code configured to, with the at least one processor, cause the apparatus at least to:
generate a first processed accelerometer sample signal from a first accelerometer sample signal;
determine a step event from the first processed accelerometer sample signal; and
control processing of a second accelerometer sample signal for a first time period.

12. The apparatus of claim 11, wherein the apparatus caused to at least generate a first processed accelerometer sample signal is further caused to generate an approximation to the magnitude of the accelerometer sample signal.

13. The apparatus of claim 11, wherein the accelerometer sample signal comprises a downsampled accelerometer signal.

14. The apparatus of claim 11, wherein the apparatus caused to at least determine a step event is further caused to:
compare the first processed accelerometer sample signal against a predetermined threshold value; and
detect the first processed accelerometer sample signal value is greater than the predetermined threshold value.

15. The apparatus of claim 11, wherein the apparatus caused to at least control processing of the second accelerometer sample signal for a first time period is further caused to switch the second accelerometer sample signal for a first time period to stop processing the second accelerometer sample signals for the first time period.

16. The apparatus of claim 15, wherein the apparatus caused to at least switch the second accelerometer sample signal for a first time period to stop processing the second accelerometer sample signals for the first time period is further caused to latch the second accelerometer sample signal for a number of samples defining the first time period.

17. The apparatus of claim 16, wherein the number of samples defining the first time period is dependent on a frequency of detected step events.

18. The apparatus of claim 11, further caused to generating the first accelerometer sample signal and the second accelerometer sample signal, wherein the second accelerometer sample signal follows the first accelerometer signal.

19. The apparatus of claim 18, wherein the apparatus caused to at least generate the first accelerometer sample signal and the second accelerometer sample signal is further caused to:
generate at least one analogue signal, wherein each analogue signal represents the acceleration in a direction; and
digitize the at least one analogue signal to generate a accelerometer sample signal.

20. The apparatus of claim 11, wherein the first accelerometer sample signal and the second accelerometer sample signal each comprise at least one accelerometer axis value.
